(19) United States
(12) Patent Application Publication
(10) Pub. No.: US 2026/0264008 A1
(43) Pub. Date: Sep. 10, 2026

(54) GAS ADSORPTION SYSTEM AND METHOD OF MANUFACTURING THE SAME

(71) Applicant: DENSO CORPORATION, Kariya-city (JP)

(72) Inventors: Shota KINOSHITA, Nisshin-city (JP); Naohisa OYAMA, Nisshin-city (JP); Hironori TATSUMI, Kariya-city (JP)

(21) Appl. No.: 19/660,787

(22) Filed: Apr. 28, 2026

Related U.S. Application Data
(62) Division of application No. 18/308,713, filed on Apr. 28, 2023.

(30) Foreign Application Priority Data
May 31, 2022 (JP) 2022-088379

(51) Int. Cl. B01D 53/32; B01D 53/04

(52) U.S. Cl. CPC B01D 53/326; B01D 53/0407; B01D 2257/504

(57) ABSTRACT

A gas adsorption system includes: a first electrode film configured to adsorb and desorb a target gas from a mixed gas containing the target gas to be recovered by an electrochemical reaction; and a second electrode film having an active material to transfer electrons to and from the first electrode film. The active material has a particle size less than or equal to 10 μm.

### CROSS REFERENCE TO RELATED APPLICATION

This application is a divisional application of U.S. patent application Ser. No. 18/308,713 filed on Apr. 28, 2023, which claims priority to Japanese Patent Application No. 2022-088379 filed on May 31, 2022, the disclosures of which are incorporated herein by reference.

### TECHNICAL FIELD

The present disclosure relates to a gas adsorption system and a method of manufacturing the gas adsorption system.

### BACKGROUND

A gas adsorption system includes a current collector, and an electrode layer containing an active material is arranged on a surface of the current collector.

### SUMMARY

A gas adsorption system includes: a first electrode film configured to adsorb and desorb a target gas from a mixed gas containing the target gas to be recovered by an electrochemical reaction; and a second electrode film having an active material to transfer electrons to and from the first electrode film. The active material has a particle size of 10 μm or less.

### BRIEF DESCRIPTION OF DRAWINGS

FIG. 1 is a cross-sectional view illustrating an electrochemical cell of a gas adsorption system according to a first embodiment;

FIG. 2 is a partial cross-sectional view of a second electrode film of the electrochemical cell shown in FIG. 1;

FIG. 3 is a diagram showing polyvinylferrocene (PVFc) used as a counter-electrode-side active material;

FIG. 4A is a diagram for explaining a first solvent in which a counter-electrode-side binder is dissolved;

FIG. 4B is a diagram for explaining a second solvent in which a counter-electrode-side active material is dissolved;

FIG. 4C is a diagram for explaining a mixed solvent in which both of a counter-electrode-side active material and a counter-electrode-side binder are dissolved;

FIG. 5 is a diagram for explaining the Hansen solubility parameters (HSP) distance;

FIG. 6 is a diagram showing a relationship between a ratio of cyclohexane and the HSP distance relative to NMP;

FIG. 7 is a diagram showing details of a mixing process;

FIG. 8 is a diagram showing a relationship between a modal particle diameter of a counter-electrode-side active material and an active material utilization rate;

FIG. 9 is a diagram showing details of a mixing process according to a second embodiment;

FIG. 10 is a view showing a counter-electrode-side active material and a counter-electrode-side binder on a surfactant according to a third embodiment; and

FIG. 11 is a diagram showing details of a mixing process according to the third embodiment.

### DETAILED DESCRIPTION

Conventionally, an electrode layer containing an active material is arranged on a surface of a current collector. In order to manufacture the electrode layer, first, a dispersion liquid is prepared by mixing an active material, a binder, a first solvent in which the binder is insoluble, and a second solvent in which the binder is soluble. Subsequently, the second solvent is removed from the dispersion liquid to provide a slurry of the active material. Thereafter, the electrode layer is produced by coating the surface of the current collector with the obtained slurry of the active material to form a coating film.

The electrode layer is configured as a part of a cell that adsorbs or desorbs acid gas. The electrode layer has a first electrode film and a second electrode film having an active material that transfers electrons to and from the first electrode film.

The inventors found that the active material does not disperse in the second solvent when the active material of the second electrode film is mixed with the second solvent in which the binder is soluble. Since the active material of the second electrode film is not dispersed in the second solvent, the active material aggregates and the particle size of the active material increases. As a result, the area of the active material that is not in contact with the conductive path increases. In this case, the active material of the second electrode film cannot be effectively used, and the performance of the cell deteriorates.

The present disclosure provides a gas adsorption system capable of effectively utilizing the active material of the second electrode film that exchanges electrons with the first electrode film. The present disclosure provides a method for manufacturing a gas adsorption system.

According to the first aspect, a gas adsorption system includes: a first electrode film configured to adsorb and desorb a target gas from a mixed gas containing the target gas to be recovered by an electrochemical reaction; and a second electrode film having an active material to transfer electrons to and from the first electrode film. The active material has a particle size of 10 μm or less.

Accordingly, since the particle size of the active material of the second electrode film is small, the area in contact with the conductive path increases inside the second electrode film. Accordingly, the amount of charge supplied from the active material is improved. As a result, the charge can be easily taken out from the active material, and the adsorption performance of the gas to be recovered is improved in the first electrode film. Therefore, the active material of the second electrode film can be effectively used.

According to the second aspect, a gas adsorption system includes: a first electrode film that adsorbs and desorbs a target gas from a mixed gas containing the target gas to be recovered by an electrochemical reaction; and a second electrode film having an active material to transfer electrons to and from the first electrode film and a binder holding the active material and having conductivity. A method of manufacturing the gas adsorption system includes forming the second electrode film.

The forming includes: adjusting a solubility parameter of a mixed solvent by mixing at least two kinds of solvents relative to the active material and the binder; and mixing the active material and the binder into the mixed solvent.

Accordingly, since the active material and the binder are mixed in the mixed solvent whose solubility parameter is adjusted, not only the binder but also the active material can be dissolved in the mixed solvent. Thus, the active material can be dispersed in the mixed solvent. Therefore, aggregation of the active material can be suppressed, and an increase in the particle size of the active material can be suppressed. As a result, the area of the active material not in contact with the conductive path can be reduced. Therefore, the active material of the second electrode film can be effectively used.

It should be noted that the reference numerals attached to the technical means indicate the correspondence with specific means described in embodiments described later.

Hereinafter, embodiments of the present disclosure will be described with reference to the drawings. In the following embodiments, the same or equivalent parts are denoted by the same reference numerals in the drawings.

### First Embodiment

A gas adsorption system according to the present embodiment recovers a target gas from a mixed gas containing the target gas by an electrochemical reaction. The target gas to be recovered is, for example, acid gas such as CO₂, NOx or SOx. The mixed gas is, for example, air. In this embodiment, a case of recovering CO₂ from the atmosphere will be described.

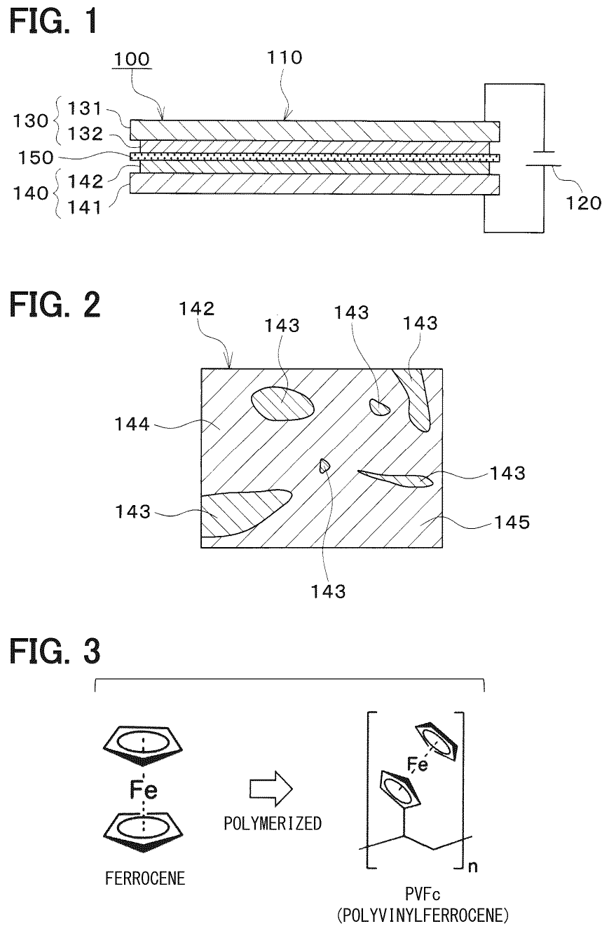

As shown in FIG. 1, a gas adsorption system 100 includes an electrochemical cell 110 and a control power supply 120. The electrochemical cell 110 is a device that collects CO₂ by adsorbing CO₂ from the atmosphere through an electrochemical reaction and by desorbing CO₂.

The electrochemical cell 110 has a first electrode 130, a second electrode 140 and a separator 150. The electrochemical cells 110 stacked with each other constitute an electric field cell stack. In FIG. 1, one of the electrochemical cells 110 making up an electric field cell stack is shown.

The first electrode 130, the second electrode 140, and the separator 150 are, for example, plate-shaped. The first electrode 130 is the negative electrode. The second electrode 140 is the positive electrode.

The first electrode 130 has a first current collector 131 and a first electrode film 132. The first current collector 131 is connected to the control power source 120 and is a porous conductive member that allows air to pass through.

For example, a carbonaceous material or a metal material can be used as the first current collector 131. Carbon paper, carbon cloth, non-woven carbon mat, porous gas diffusion layer (GDL), or the like can be used as the carbonaceous material forming the first current collector 131. As the metal material forming the first current collector 131, for example, a mesh structure made of metal such as Al, Ni, Ti, or SUS can be used.

The first electrode film 132 is a working electrode that adsorbs and desorbs CO₂ from the air containing CO₂ through an electrochemical reaction. The first electrode film 132 has a CO₂ adsorbent, a working-electrode-side conductive aid, and a working-electrode-side binder.

The CO₂ adsorbent adsorbs CO₂ by receiving electrons, and desorbs the adsorbed CO₂ by releasing electrons. For example, polyanthraquinone can be used as the CO₂ adsorbent. Alternatively, carbon or metal oxides can be used as the CO₂ adsorbent.

The working-electrode-side conductive aid is a conductive substance that forms a conductive path to the CO₂ adsorbent. Carbon materials such as carbon nanotubes, carbon black, or graphene can be used as the working-electrode-side conductive aid.

Mixing of the CO₂ adsorbent and the working-electrode-side conductive aid may be carried out by dissolving or dispersing the working-electrode-side conductive aid in an organic solvent such as NMP (N-methylpyrrolidone), such that the working-electrode-side conductive aid dispersed in the organic solvent is in contact with the CO₂ adsorbent.

The working-electrode-side binder is a holding material having adhesive strength. The working-electrode-side binder holds the CO₂ adsorbent and the working-electrode-side conductive aid to the first current collector 131. As a result, it is possible to ensure the movement of electrons among the first current collector 131, the CO₂ adsorbent, and the working-electrode-side conductive aid. In addition, the CO₂ adsorbent is less likely to separate from the first current collector 131, and a decrease in the CO₂ adsorption amount of the electrochemical cell 110 over time can be suppressed.

A non-fluid substance having no fluidity can be used as the working-electrode-side binder. Examples of non-fluid substances include gel substances and solid substances. An ionic liquid gel can be used as the gel substance. As the solid substance, for example, a solid electrolyte, a conductive resin, or the like can be used.

When a solid electrolyte is used as the working-electrode-side binder, it is desirable to use an ionomer made of a polymer electrolyte or the like in order to increase the contact area with the CO₂ adsorbent. When a conductive resin is used as the working-electrode-side binder, an epoxy resin containing Ag or the like as the conductive filler, a fluororesin such as polytetrafluoroethylene (PTFE), polyvinylidene fluoride (PVDF) can be used.

Then, a mixture of the CO₂ adsorbent, the working-electrode-side conductive aid, and the working-electrode-side binder is formed, and this mixture is adhered to the first current collector 131. The CO₂ adsorbent and the working-electrode-side conductive aid are held by the working-electrode-side binder. Therefore, the CO₂ adsorbent and the working-electrode-side conductive aid can be firmly held by the working-electrode-side binder. In addition, the CO₂ adsorbent and the working-electrode-side conductive aid are less likely to separate from the first current collector 131.

The second electrode 140 has a second current collector 141 and a second electrode film 142. The second current collector 141 is a conductive member connected to the control power supply 120. The second current collector 141 may be made of the same material as the first current collector 131, or may be made of a different material.

The second electrode film 142 is a counter electrode that exchanges electrons with the first electrode film 132. As shown in FIG. 2, the second electrode film 142 has a counter-electrode-side active material 143, a counter-electrode-side conductive aid 144 and a counter-electrode-side binder 145.

The counter-electrode-side active material 143 is an auxiliary electroactive species that exchanges electrons with the CO₂ adsorbent of the first electrode film 132. The counter-electrode-side active material 143 can take in and out electrons by changing the valence of the metal and by moving charges into and out of the rr-electron cloud.

As the counter-electrode-side active material 143, for example, a metal complex that allows electron transfer by changing the valence of metal ions can be used. Examples of the metal complex include cyclopentadienyl metal complexes such as ferrocene, nickelocene and cobaltocene, and porphyrin metal complexes.

In this embodiment, a compound having a ferrocene skeleton is used as the counter-electrode-side active material 143. As shown in FIG. 3, as the counter-electrode-side active material 143, polyvinylferrocene (PVFc) in which ferrocene is polymerized is used.

The counter-electrode-side conductive aid 144 is a conductive material that forms a conductive path to the counter-electrode-side active material 143. The counter-electrode-side conductive aid 144 is used by being mixed with the counter-electrode-side active material 143. The counter-electrode-side conductive aid 144 may be made of the same material as the working-electrode-side conductive aid, or may be made of a different material. The counter-electrode-side conductive aid 144 is, for example, particulate.

The counter-electrode-side binder 145 has conductivity and is capable of holding the counter-electrode-side active material 143 and the counter-electrode-side conductive aid 144 on the second current collector 141. The counter-electrode-side binder 145 may be the same material as the working-electrode-side binder, or may be a different material.

The separator 150 is disposed between the first electrode film 132 and the second electrode film 142. The separator 150 separates the first electrode film 132 and the second electrode film 142 from each other. That is, the separator 150 prevents physical contact between the first electrode film 132 and the second electrode film 142. Moreover, the separator 150 suppresses electrical short-circuiting between the first electrode film 132 and the second electrode film 142.

The separator 150 is made of a cellulose film, a polymer, a composite material of polymer or ceramic. A porous material may be used as the separator 150.

An ion conductive member may be provided between the first electrode film 132 and the separator 150 or between the second electrode film 142 and the separator 150. The ion conductive member facilitates electrical conduction to the CO₂ adsorbent.

The control power supply 120 is a power supply device for the gas adsorption system 100. The control power supply 120 supplies power to each device of the gas adsorption system 100. The control power supply 120 changes the potential difference between the first electrode 130 and the second electrode 140 by applying a predetermined voltage to the electrochemical cell 110 according to instructions.

The gas adsorption system 100 includes: a housing that houses the electrochemical cell 110; an introduction device that introduces air into the housing; a vacuum device that evacuates the inside of the housing; and a collector configured to collect the desorbed CO₂ from the housing to a CO₂ utilization device such as a tank, in addition to the electrochemical cell 110.

The gas adsorption system 100 includes a control device that controls the housing, the electrochemical cell 110, the introduction device, the vacuum device, and the collector. The control device controls the control power supply 120 and the like according to the control program. The above is the overall configuration of the gas adsorption system 100 according to the present embodiment.

Next, the operation of the gas adsorption system 100 will be described. The gas adsorption system 100 sequentially performs an adsorption step, a removal step, a desorption step, and a recovery step to capture CO₂ into the CO₂ utilization device.

In the adsorption step, the control device controls the control power supply 120 to apply an adsorption potential between the first electrode 130 and the second electrode 140 of the electrochemical cell 110. Thereby, electron donation by the counter-electrode-side active material 143 of the second electrode film 142 and electron withdrawal by the CO₂ adsorbent of the first electrode film 132 can be realized simultaneously.

When an adsorption potential is applied between the first electrode film 132 and the second electrode film 142, the counter-electrode-side active material 143 of the second electrode film 142 emits electrons, and the electrons are transferred from the second electrode film 142 to the first electrode film 132. The CO₂ adsorbent of the first electrode film 132 receives electrons.

The CO₂ adsorbent that has received the electrons has a higher binding force for CO₂, and binds and adsorbs CO₂ contained in the atmosphere. In this way, in the electrochemical cell 110, electrons are supplied from the second electrode film 142 to the first electrode film 132 by applying an adsorption potential between the first electrode film 132 and the second electrode film 142. The CO₂ adsorbent binds to CO₂ as electrons are supplied. Thus, the electrochemical cell 110 can capture CO₂ from the atmosphere.

After the adsorption step, the control device performs the removal step of scavenging the interior of the housing. As a result, the inside of the housing is brought into a vacuum state.

After the removal step, in the desorption step, the control device controls the control power supply 120 to apply a desorption potential between the first electrode film 132 and the second electrode film 142 of the electrochemical cell 110. Thereby, the electron donation by the CO₂ adsorbent of the first electrode film 132 and the electron withdrawal by the counter-electrode-side active material 143 of the second electrode film 142 can be realized simultaneously.

The CO₂ adsorbent of the first electrode film 132 emits electrons. The CO₂ adsorbent desorbs and releases CO₂ as the binding force of CO₂ decreases. The counter-electrode-side active material 143 of the second electrode film 142 receives electrons.

After the desorption step, in the recovery step, the control device discharges CO₂ released from the CO₂ adsorbent from the housing and collects CO₂ in the CO₂ utilization device through the piping. After that, the control device introduces the atmosphere into the housing and repeats the above cycle.

Next, a formation process for forming the second electrode film 142 of the electrochemical cell 110 will be described. The formation process includes a mixing step of dissolving the counter-electrode-side active material 143 and the counter-electrode-side binder 145 in a solvent.

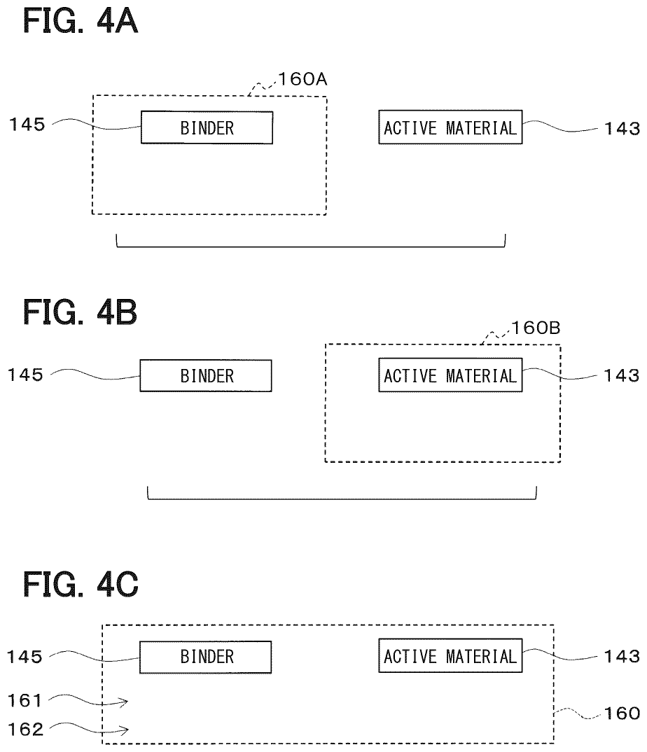

As shown in FIG. 4A, when a material in which the counter-electrode-side binder 145 dissolves is selected as the first solvent 160A, the counter-electrode-side binder 145 dissolves in the first solvent 160A, but the counter-electrode-side active material 143 does not dissolve in the first solvent 160A. Therefore, the dispersibility of the counter-electrode-side active material 143 in the first solvent 160A is lowered.

The counter-electrode-side active material 143 has little polarity and is difficult to dissolve in a polar solvent. Therefore, the counter-electrode-side active material 143 is difficult to dissolve in the polar solvent that dissolves the counter-electrode-side active binder 145. For example, when NMP, which is a polar solvent, is selected as the first solvent, and PVFc is used as the counter-electrode-side active material 143, the counter-electrode-side active material 143 cannot be dissolved and dispersed in NMP even if the volume of NMP is 200 times or more. Therefore, only a suspension containing precipitates is produced, and the particle size of the counter-electrode-side active material 143 is very large. If the second electrode film 142 is formed in such a state, the counter-electrode-side active material 143 aggregates in the second electrode film 142 to increase the particle diameter, and the performance of the electrochemical cell 110 cannot be exhibited.

As shown in FIG. 4B, when a material in which the counter-electrode-side active material 143 dissolves is selected as the solvent 160B, the counter-electrode-side active material 143 dissolves in the solvent 160B, but the counter-electrode-side binder 145 does not dissolve in the solvent 160B. Therefore, it is difficult to secure the film strength of the second electrode film 142.

According to the present embodiment, as shown in FIG. 4C, a mixed solvent 160 is prepared by mixing at least two kinds of solvents so as to adjust the solubility parameters for the counter-electrode-side active material 143 and the counter-electrode-side binder 145. The counter-electrode-side active material 143 and the counter-electrode-side binder 145 are mixed into the mixed solvent 160. That is, a material in which both the counter-electrode-side active material 143 and the counter-electrode-side binder 145 are dissolved is prepared as the mixed solvent 160.

In this embodiment, two kinds of solvents, e.g., a first solvent 161 and a second solvent 162 are used to make the mixed solvent 160. The first solvent 161 is a solvent capable of dissolving the counter-electrode-side active material 143. The first solvent 161 is a hydrophobic non-polar solvent. The second solvent 162 is a solvent capable of dissolving the counter-electrode-side binder 145. The second solvent 162 is a hydrophilic polar solvent.

As the first solvent 161, ethylbenzene, cyclohexanone, cyclohexane, an aromatic high-boiling-point hydrocarbon solvent, and p-cymene can be used. For example, cyclohexane (C₆H₁₂) is represented by the following Chemical Formula 1.

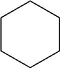

Alternatively, benzyl benzoate, dimethylcyclohexane, xylene, and methylcyclohexane can be used as the first solvent 161. For example, benzyl benzoate is represented by the following Chemical Formula 2.

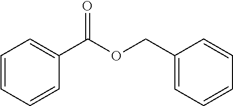 [SMILES: O=C(OCc1ccccc1)c1ccccc1]

Alternatively, butyl benzoate, heptane, and hexane can be used as the first solvent 161. For example, butyl benzoate is represented by the following Chemical Formula 3.

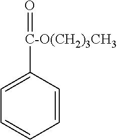

Alternatively, isophorone, d-limonene, cyclopentyl methyl ether, tributyl phosphate, FAME, diisobutyl ketone, methyl isoamyl ketone, methyl oleate, and anisole can be used as the first solvent 161. For example, isophorone is represented by the following Chemical Formula 4.

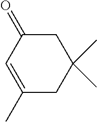

Alternatively, methyl propyl ketone, methyl isobutyl ketone, methyl ethyl ketone, amyl acetate, dimethyl isosorbitanate, butyl acetate, butyl propionate, and isobutyl isobutyrate can be used as the first solvent 161.

An aprotic polar solvent can be used as the second solvent 162. For example, NMP can be used as the second solvent 162. NMP is represented by the following Chemical Formula 5.

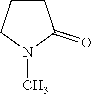

Alternatively, dimethylacetamide (DMAc) can be used as the second solvent 162. DMAc is represented by the following Chemical Formula 6.

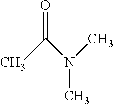

Alternatively, dimethylformamide (DMF) can be used as the second solvent 162. DMF is represented by the following Chemical Formula 7.

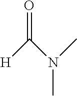

Alternatively, dimethylsulfoxide (DMSO) can be used as the second solvent 162. DMSO is represented by the following Chemical Formula 8.

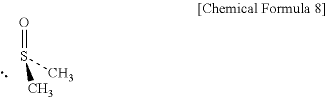

Then, the solubility parameter of the mixed solvent 160 is adjusted so that the Hansen solubility parameters (HSP) distance between the counter-electrode-side active material 143 and the mixed solvent 160 is equal to or less than a predetermined value for the active material. The HSP distance is a value representing the solubility of two substances. The smaller the value of the HSP distance, the easier it melts.

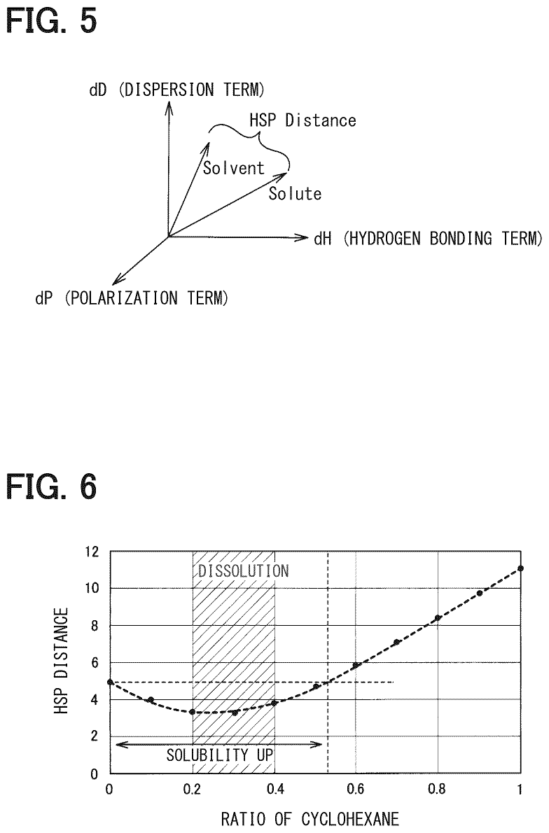

As shown in FIG. 5, the HSP distance is determined by a dispersion term dD, a polarization term dP, and a hydrogen bonding term dH of the solvent. That is, the HSP distance depends on the size of the Hansen sphere of each material. Since the two solvents are mixed, the HSP distance Ra is represented by the following Equation 1.

$${R}_{a} = \sqrt{4 {( {dD}_{1} - {dD}_{2} )}^{2} + {( {dP}_{1} - {dP}_{2} )}^{2} + {( {dH}_{1} - {dH}_{2} )}^{2}} \qquad ( Equation 1 )$$

In other words, the closer the numerical values of each term of the two solvents, the smaller the HSP distance, so it can be said that the substance is more soluble.

Thus, the solubility of a substance can be estimated to some extent by the solubility parameter. Since the solubility parameter of the mixed solvent 160 is a volume average of the parameters of each solvent, it is possible to control the solubility parameter of the mixed solvent 160 by adjusting the combination and the mixture ratio of solvents.

For example, cyclohexane is selected as the first solvent 161, NMP is selected as the second solvent 162, and PVFc shown in FIG. 3 is used as the counter-electrode-side active material 143. In this case, as shown in FIG. 6, the solubility can be improved by setting the HSP distance, which is the difference in the solubility parameter with the mixed solvent 160 relative to PVFc, to be lower than or equal to 5.0 which is the HSP distance with NMP alone. For example, PVFc, which is the counter-electrode-side active material 143, can be dissolved in the mixed solvent 160 by setting the ratio of cyclohexane to NMP in the range of 20% to 40%.

It should be noted that setting the HSP distance to a predetermined value or less can be similarly considered for combinations of other solvents and active materials. For example, as a concept of setting the predetermined value for the active material, the predetermined value for the active material can be set to be equal to or less than the HSP distance between the counter-electrode-side active material 143 to be dissolved and each single solvent before being mixed.

Thus, for PVFc, the solubility in the mixed solvent 160 can be improved by setting the predetermined value for the active material of the HSP distance to 5.0 or less. Moreover, it is preferable to set the predetermined value for the active material of the HSP distance to 4.5 or less. Further, by setting the predetermined value for the active material of the HSP distance to 4.0 or less, it can set a dissolved state in the mixed solvent 160. In the example shown in FIG. 6, the HSP distance is 3.178, when NMP, which is the second solvent 162, is mixed with 26% cyclohexane, which is the first solvent 161.

When 42% benzyl benzoate, which is the first solvent 161, is mixed with NMP, which is the second solvent 162, the HSP distance is 3.351. When 48% butyl benzoate, which is the first solvent 161, is mixed with NMP, which is the second solvent 162, the HSP distance is 3.351. When 59% isophorone, which is the first solvent 161, is mixed with NMP, which is the second solvent 162, the HSP distance is 3.351.

Further, since the counter-electrode-side binder 145 is also desired to be dissolved in the mixed solvent 160, the solubility parameter of the mixed solvent 160 is adjusted so that the HSP distance between the counter-electrode-side binder 145 and the mixed solvent 160 is equal to or less than a predetermined value for the binder. For example, when PVDF is used as the counter-electrode-side binder 145, it is preferable to set the predetermined value for the binder of the HSP distance to 10 or less.

Furthermore, the HSP distance between the first solvent 161 and the counter-electrode-side active material 143 and the HSP distance between the second solvent 162 and the counter-electrode-side binder 145 are defined. That is, the first solvent 161 is used such that the HSP distance between the counter-electrode-side active material 143 and the first solvent 161 is equal to or less than the predetermined value for the first solvent. The second solvent 162 is used such that the HSP distance between the counter-electrode-side binder 145 and the second solvent 162 is equal to or less than the predetermined value for the second solvent.

Each predetermined value for the HSP distance should satisfy at least one of the value for the mixed solvent 160 and the value for each of the solvents 161, 162.

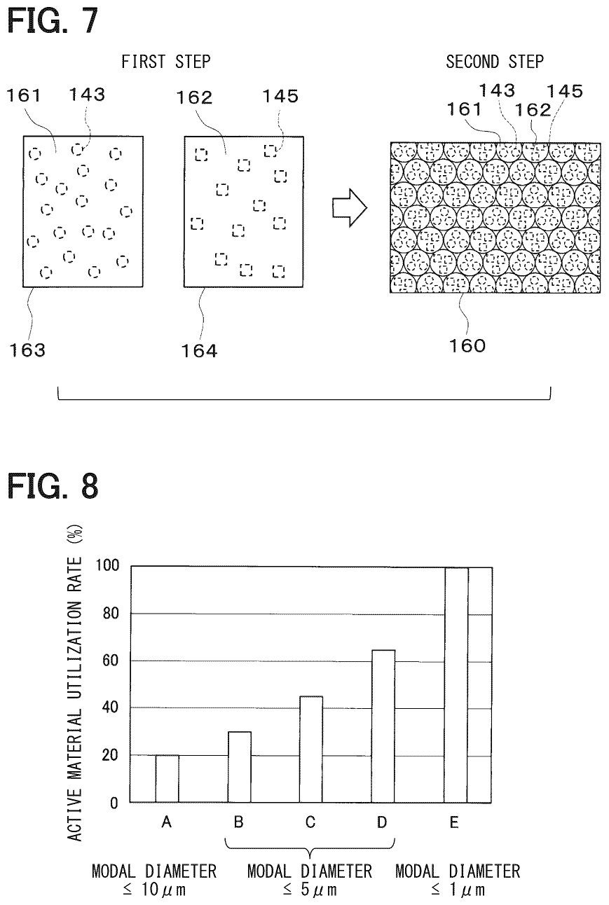

As shown in FIG. 7, as a first step, a first solution 163 is prepared by dissolving the counter-electrode-side active material 143 in the first solvent 161. A second solution 164 is prepared by dissolving the counter-electrode-side binder 145 in the second solvent 162.

The counter-electrode-side conductive aid 144 may be mixed with either the first solution 163 or the second solution 164 in advance, or may be added after the first solution 163 and the second solution 164 are mixed. For example, adding carbon to the first solution 163 makes it difficult for the counter-electrode-side active material 143 to aggregate.

Subsequently, as a second step, the first solution 163 and the second solution 164 are mechanically mixed. As a result, the counter-electrode-side active material 143 and the counter-electrode-side binder 145 are dissolved in the mixed solvent 160.

Alternatively, the mixed solvent 160 is prepared by mixing the first solvent 161 and the second solvent 162, and the counter-electrode-side active material 143 is dissolved in the mixed solvent 160. The counter-electrode-side binder 145 may be separately dissolved in the second solvent 162 and then mixed. At that time, carbon may be added to a mixed solution in which the counter-electrode-side active material 143 is dissolved in the mixed solvent 160. Then, the mixed solution is mixed with the second solvent 162 (the second solution 164) in which the counter-electrode-side binder 145 is dissolved. It is possible to suppress aggregation of the counter-electrode-side active material 143 due to a change in the solvent ratio, when the mixed solution is mixed with the second solvent 162, by mixing with the carbon in advance.

After the mixing step, a coating step of coating the second current collector 141 with a paste obtained by concentrating the solvent is performed. In addition, a drying step is performed to dry the second electrode film 142 in the paste state. Thus, the formation process is finished.

The inventors examine the active material utilization rate with respect to the modal particle size of the counter-electrode-side active material 143 in the CO₂ recovery by the electrochemical cell 110 including the second electrode film 142 obtained in the above formation process. The active material utilization rate is represented by a ratio between the number of electrons entering and exiting the counter-electrode-side active material 143 contained in the second electrode film 142 and the number of electrons flowing through the electrochemical cell 110.

As samples, a sample A having a modal particle size of 10 μm or less, samples B, C, and D having a modal particle size of 5 μm or less, and a sample D having a modal particle size of 1 μm or less were prepared. The results are shown in FIG. 8.

As shown in FIG. 8, the sample A with a modal particle size of 10 μm or less had an active material utilization rate of 20%, which means that the counter-electrode-side active material 143 is effectively utilized.

The samples B, C, and D having a modal particle size of 5 μm or less exhibited higher active material utilization rates than the sample A. Furthermore, in the case of sample D having a modal particle size of 1 μm or less, the active material utilization rate was 100%. Therefore, the smaller the particle size of the counter-electrode-side active material 143 in the second electrode film 142, the better the contact between the particle surface and the conductive path. Since the amount of electrons supplied from the counter-electrode-side active material 143 is increased, the adsorption performance is improved. Therefore, sufficient performance of the electrochemical cell 110 can be obtained by setting the particle diameter of the counter-electrode-side active material 143 to 10 μm or less, preferably 1 μm or less.

As described above, when forming the second electrode film 142, the counter-electrode-side active material 143 and the counter-electrode-side binder 145 are mixed in the mixed solvent 160 whose solubility parameter is adjusted. Thereby, not only the counter-electrode-side binder 145 but also the counter-electrode-side active material 143 can be dissolved in the mixed solvent 160. Therefore, since the counter-electrode-side active material 143 can be dispersed in the mixed solvent 160, aggregation of the counter-electrode-side active material 143 can be suppressed. That is, the particle size of the counter-electrode-side active material 143 in the second electrode film 142 can be reduced.

As described above, since the particle size of the counter-electrode-side active material 143 of the second electrode film 142 is small, the area of the counter-electrode-side active material 143 that does not contact the conductive path can be reduced. Therefore, it becomes easier to take out the charge from the counter-electrode-side active material 143. Therefore, the counter-electrode-side active material 143 of the second electrode film 142 can be effectively used. Accordingly, the CO₂ adsorption performance of the electrochemical cell 110 can be improved.

The counter-electrode-side active material 143 corresponds to an active material, and the counter-electrode-side binder 145 corresponds to a binder.

### Second Embodiment

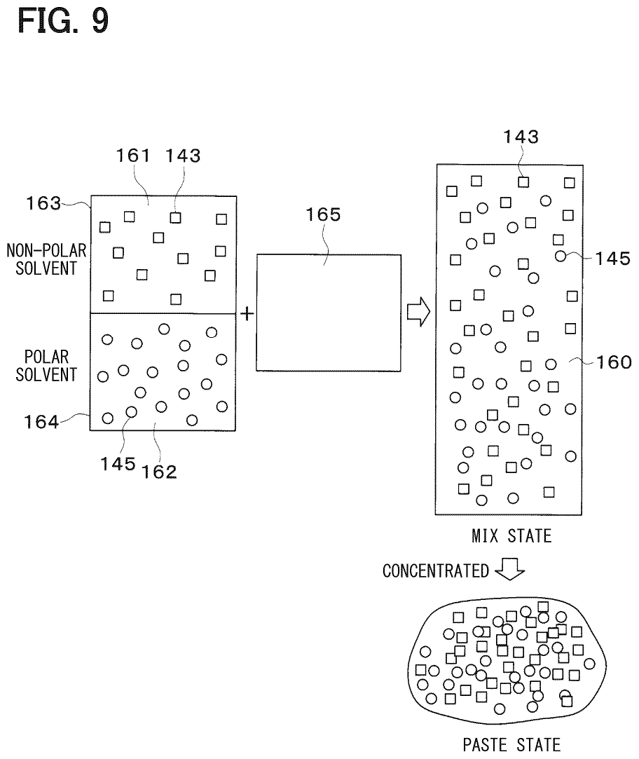

In the present embodiment, portions different from the first embodiment will be mainly described. As shown in FIG. 9, in the mixing step, the mixed solvent 160 is made by mixing the first solvent 161 and the second solvent 162 further with the third solvent 165. The mixed solvent 160 to which the third solvent 165 has been added is concentrated to form a paste, which is then applied to the second current collector 141. Note that the mixed solvent 160 does not necessarily need to be concentrated.

The third solvent 165 is a bipolar solvent that is soluble in both the first solvent 161 and the second solvent 162. The third solvent 165 can create a state in which the counter-electrode-side active material 143 and the counter-electrode-side binder 145 are adjacent to each other.

The third solvent 165 may be lower alcohols such as methanol (CH₃—OH), ethanol (CH₃—CH₂—OH), propanol (CH₃—(CH₂)₂—OH), or butanol, which are represented as R—OH. R corresponds to a hydrophobic group and OH corresponds to a hydrophilic group. Alternatively, a lower ketone such as acetone (C₃H₆O) can be used as the third solvent 165. In the case of acetone, C₃H₆ corresponds to a hydrophobic group and O corresponds to a hydrophilic group.

By using the third solvent 165 in this manner, the counter-electrode-side active material 143 can be more easily dispersed in the mixed solvent 160. Also, the counter-electrode-side active material 143 can be more uniformly mixed in the mixed solvent 160.

### Third Embodiment

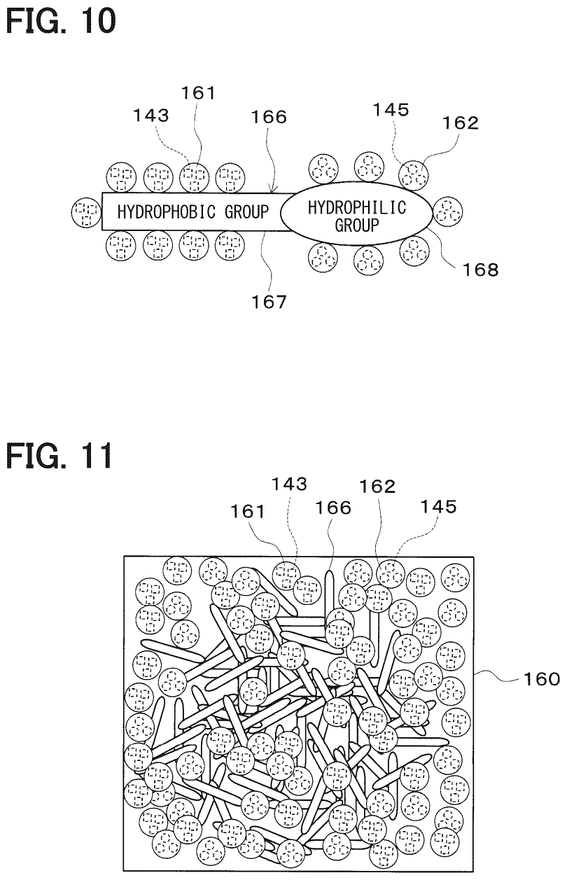

In the present embodiment, differences from the second embodiment will be mainly described. As shown in FIGS. 10 and 11, in the mixing step, the mixed solvent 160 is made by mixing a mixture of the first solvent 161 and the second solvent 162 with a surfactant 166.

The surfactant 166 is a substance that makes both the first solvent 161 and the second solvent 162 compatible. As shown in FIG. 10, the surfactant 166 has a hydrophobic group 167 and a hydrophilic group 168. The fine particles of the first solvent 161 containing the counter-electrode-side active material 143 adhere to the hydrophobic groups 167 of the surfactant 166. The fine particles of the second solvent 162 containing the counter-electrode-side binder 145 adhere to the hydrophilic groups 168 of the surfactant 166.

Therefore, as shown in FIG. 11, the mixed solvent 160 includes: micelle-like fine particles in which the counter-electrode-side active material 143 is on the surfactant 166; the first solvent 161 containing the counter-electrode-side active material 143; and the second solvent 162 containing the counter-electrode-side binder 145, in the mixed manner. Thus, the same effects as those of the second embodiment can be obtained.

### Other Embodiment

The configuration of the gas adsorption system 100 shown in each of the embodiments is an example, and is not limited to the above. The other configurations that can realize the present disclosure are also possible. For example, the gas containing CO₂ is not limited to the atmosphere air, while containing an acid gas such as CO₂.

What is claimed is:

1. A method of manufacturing a gas adsorption system including: a first electrode film that adsorbs and desorbs a target gas from a mixed gas containing the target gas to be recovered by an electrochemical reaction; and a second electrode film having an active material to transfer electrons to and from the first electrode film and a binder holding the active material and having conductivity, the method comprising:
forming the second electrode film, wherein
the forming of the second electrode film includes
adjusting a solubility parameter of a mixed solvent by mixing at least two kinds of solvents, relative to the active material and the binder, and
mixing the active material and the binder into the mixed solvent.

2. The method according to claim 1, wherein
the solubility parameter of the mixed solvent is adjusted such that a HSP distance between the active material and the mixed solvent is equal to or less than a predetermined value for the active material, in the mixing.

3. The method according to claim 1, wherein
a compound having a ferrocene skeleton is used as the active material, in the mixing.

4. The method according to claim 1, wherein
the solubility parameter of the mixed solvent is adjusted such that a HSP distance between the binder and the mixed solvent is equal to or less than a predetermined value for the binder, in the mixing.

5. The method according to claim 1, wherein
the binder contains polyvinylidene fluoride, in the mixing.

6. The method according to claim 1, wherein
a first solvent capable of dissolving the active material and a second solvent capable of dissolving the binder are used to prepare the mixed solvent, in the mixing.

7. The method according to claim 6, wherein
a HSP distance between the active material and the first solvent is equal to or less than a predetermined value for the first solvent, in the mixing, and
a HSP distance between the binder and the second solvent is equal to or less than a predetermined value for the second solvent, in the mixing.

8. The method according to claim 6, wherein
a mixture of the first solvent and the second solvent is mixed with a third solvent that is soluble in both the first solvent and the second solvent, in the mixing.

9. The method according to claim 6, wherein
a surfactant is mixed into a mixture of the first solvent and the second solvent so as to make both the first solvent and the second solvent compatible, so as to provide the mixed solvent, in the mixing.
